(19) United States
(12) Patent Application Publication
(10) Pub. No.: US 2009/0293603 A1
(43) Pub. Date: Dec. 3, 2009

(54) METHOD AND SYSTEM FOR DETERMINING WHEEL PARAMETER CONSISTENCY

(76) Inventor: Michael Wayne Douglas, St. Charles, MO (US)

Correspondence Address: Patrick W. Rasche;Armstrong Teasdale LLP, Suite 2600, One Metropolitan Square, St. Louis, MO, 63102, US

(21) Appl. No.: 12/475,199

(22) Filed: May 29, 2009

Related U.S. Application Data
(60) Provisional application No. 61/057,142, filed on May 29, 2008.

(51) Int. Cl. G01M 17/02; G01B 5/08

(52) U.S. Cl. 73/146; 33/203

(57) ABSTRACT

A method and system for a wheel assembly service system are provided. The system includes a rotatable spindle configured to receive a wheel assembly, a load device configured to apply a load to the wheel assembly during a rotation of the wheel assembly on the spindle, and a controller configured to rotate the wheel assembly about a rotational axis of the wheel assembly, apply a load to the wheel assembly using the load device, determine a dimensional parameter of the wheel assembly, and output the determined effective diameter.

### BACKGROUND OF THE INVENTION

This invention relates generally to vehicle wheel assembly service systems and, more particularly, to a method and system for measuring vehicle wheel parameters at loaded conditions.

Vehicle wheels or wheel assemblies including a tire and a rim are manufactured and maintained to close dimensional tolerances. The dimensions may be affected by the loading on the wheel assembly when a measurement of a wheel parameter is acquired. For example, during servicing, most wheel assemblies are removed from the vehicle and placed on a vehicle wheel assembly service system, such as a balancer or a tire changer. The entire vehicle may also be lifted off of the wheels for alignments or other procedures. Such procedures tend to unload the wheel assemblies by removing the weight that the wheel was bearing. The difference between a dimensional parameter of the wheel assembly in a loaded condition and the dimensional parameter of the wheel assembly in an unloaded condition may be within the correction tolerance of the wheel assembly and/or wheel assembly service system making determining an out of tolerance condition difficult.

At least some known vehicle wheel assembly service systems have attempted to address a problem with cars where two wheels on the same axle are not the same diameter. The mismatch in diameter causes steering wheel pull. The wheel alignment system described in U.S. Pat. No. 6,237,234 to Jackson attempts to address this issue by indirectly detecting wheel mismatch using machine vision techniques of a wheel aligner while the vehicle is rolled on the alignment lift rack.

A more recent issue has surfaced with all-wheel drive (AWD) vehicles equipped with automatic transfer cases. These vehicles require all four wheels or at least two opposing wheels on opposite sides of the vehicle to be close to equal effective diameter to prevent unintentional engagement of the transfer case on dry surfaces. The vehicle computer attempts to lock the front and rear axles together if a difference in axle speeds is detected. This feature works well if the wheels are actually spinning at different speeds on loose surfaces, but when the detected difference in axle speeds is caused by different effective wheel diameters among the four wheels, the transfer case is continuously engaged, reducing fuel economy and potentially causing transmission transfer case overheating and failure.

This new issue requires an accuracy of effective diameter measurement on the order of 0.2% of nominal wheel diameter, smaller than the known alignment system can reliably measure because the methodology described in Jackson uses an approximation of the diameter based on measuring an amount of rotation and a distance traveled during a short roll that uses only a fraction of a full rotation of the wheels. Another problem is that the determination of a mismatch by the aligner requires interruption of the alignment procedure. What is needed is a more accurate measurement of the effective diameter, performed on wheel service equipment before the assemblies are mounted on a vehicle and before beginning a wheel alignment.

No industry standard exists for determining differences in wheel diameter. Sometimes the wheels are compared to each other by manually measuring the circumference with a tape measure and applying a specification. This solution does not account for tire spring rate differences. Under the load of the car the tire compresses at the contact spot, creating an “effective diameter” which could vary despite the unloaded diameters being the same due to tire stiffness variation between tires. Slight differences in inflation pressure can also cause different effective diameters under load compared to a manually measured unloaded circumference.

Another method used to compare diameters is to specify a maximum allowed variation in tread depth between tires. The drawback with this method is that it assumes that the tires being compared are of the same manufacture, type, and marked size. In some cases even the same exact type and size replacement tire does not guarantee the same nominal diameter because the tolerances of manufacture can be looser than the tight variation specs to combat this recent AWD issue.

Statements made in various manufacturer technical service bulletins indicate the nature of the problem. For example, a diameter specification of less than ⅛″ diameter or 1/16″ radius causes only a four revolution difference per mile between the tires yet this is enough to overheat the differential of viscous couplings by forcing them to operate 100% of the time. Another statement indicates 4WD and AWD vehicles require special attention to insure that all four tires are closely matched in diameter to avoid strain and possible damage to the vehicle's differentials and/or viscous couplings. Other statements indicating the importance of consistency between wheel dimensions include all tires must be within ¼″ circumference of each other, you may need to buy four new tires even if only one is bad, and all tires must be less than 0.2% of nominal diameter of each other. The accuracy/repeatability of the indirect measurement of the mentioned aligner can not be great enough to be used for this tight of a specification. It is also impossible to reliably measure diameter to this level of accuracy using a tape measure.

### BRIEF DESCRIPTION OF THE INVENTION

In one embodiment, a wheel assembly service system includes a rotatable spindle configured to receive a wheel assembly, a load device configured to apply a load to the wheel assembly during a rotation of the wheel assembly on the spindle, and a controller configured to rotate the wheel assembly about a rotational axis of the wheel assembly, apply a load to the wheel assembly using the load device, determine a dimensional parameter of the wheel assembly, and output the determined effective diameter. A wheel assembly generally comprises a tire coupled to a rim and is removably mounted for rotation to spindle.

In another embodiment, a method of measuring a parameter of a wheel assembly includes rotating a first wheel assembly about a rotational axis, determining an effective diameter of the first wheel assembly during the rotation, and outputting the determined effective diameter of the first wheel assembly during the rotation.

In yet another embodiment, a wheel assembly service system includes a spindle configured to receive a wheel assembly wherein the wheel assembly includes a rim and a tire mounted on the rim. The spindle is also configured to rotate the wheel assembly about a rotational axis of the wheel assembly. The wheel assembly service system includes a load device configured to apply a load to the wheel assembly and a controller communicatively coupled to the spindle and the load device. The controller is configured to control a rotation of the spindle and a force applied to the wheel assembly using the load device. The controller is further configured to measure a diameter of one or more wheel assembly in a loaded state, determine an effective diameter of each wheel assembly using the measured diameter in the loaded state, and store the determined effective diameters in a memory associated with the controller. The controller is further configured to display the effective diameter of one or more of the wheel assemblies.

### BRIEF DESCRIPTION OF THE DRAWINGS

FIGS. 1-5 show exemplary embodiments of the method and system described herein.

FIG. 1 is schematic diagram of a wheel assembly service system in accordance with an embodiment of the present invention;

FIG. 2 is a screen display of an exemplary user interface that may be used with the wheel assembly service system shown in FIG. 1;

FIG. 3 is a screen display of a portion of a user interface including an exemplary wheel service feature display field that may be used with wheel assembly service system shown in FIG. 1;

FIG. 4 is a screen display of a portion of a user interface including another wheel service feature display field that may be used with wheel assembly service system shown in FIG. 1; and

FIG. 5 is a flow diagram of an exemplary method of determining a consistency of a measured parameter of wheel assembly.

### DETAILED DESCRIPTION OF THE INVENTION

The following detailed description illustrates embodiments of the invention by way of example and not by way of limitation. It is contemplated that the invention has general application to contact and non-contact measurement of rotatable bodies in industrial, commercial, and residential applications.

As used herein, an element or step recited in the singular and proceeded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

As used herein “unloaded diameter” refers to the diameter of the wheel assembly under no load or a light contact load, and “effective diameter” refers to a measurement of the diameter of the wheel assembly under a known radial load wherein the tire is being compressed such that a spring rate of the tire contributes to the measurement more closely to what actually happens to tires on the vehicle. Also as used herein, “wheel assembly service system” refers to systems such as but not limited to wheel balancers and tire changers.

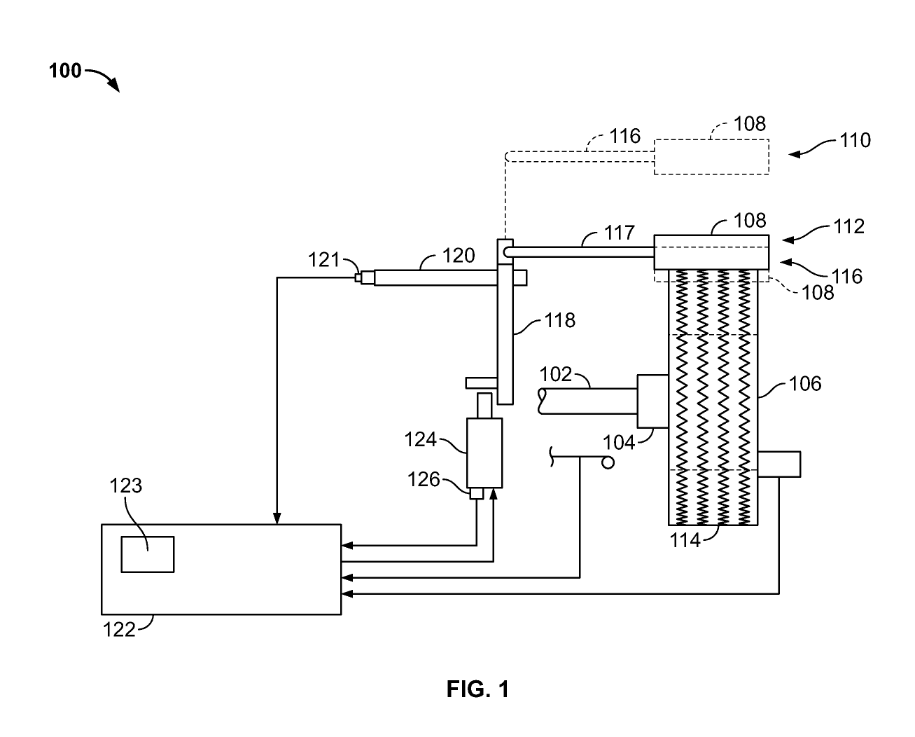

FIG. 1 is schematic diagram of a wheel assembly service system 100 in accordance with an embodiment of the present invention. In various embodiments, wheel assembly service system includes for example, wheel balancers, or tire changers. In one embodiment wheel assembly service system 100 comprises a balancer including a rotatable shaft or spindle 102 driven by a drive mechanism (not shown) such as an electric motor. A shaft encoder 104 is mounted on spindle 102 to provide speed and rotational position information regarding spindle 102. A wheel assembly 106 under test is removably mounted for rotation to spindle 102.

A load roller 108 is positionable adjacent wheel assembly 106. In a first position 110, load roller 108 is maintained a distance away from wheel assembly 106. In a second position 112, load roller 108 is maintained in light contact with wheel assembly 106 such that load roller 108 contacts an outer peripheral surface 114 of wheel assembly 106 but does not apply a substantial force to wheel assembly 106. As used herein, “light contact” refers to just enough force to enable load roller 108 to track along surface 114. In a third position 116, load roller 108 engages wheel assembly 106 such that a radially inward force is applied to surface 114. Load roller 108 is coupled to a shaft 117 which in turn is coupled to an arm 118 configured to pivot about a shaft 120. A sensor 121 detects an amount and direction of rotation of shaft 120. A controller 122 is communicatively coupled to an air cylinder 124. Controller 122 includes a memory 123 for storing data and/or a program that is executable by controller 122 for implementing the procedures described herein. Controller 122 directs arm 118 to pivot to place load roller 108 into any of various positions by actuating air cylinder 124. Air pressure to cylinder 124 is variably adjusted by controller 122. A sensor 126 provides air pressure feedback that enables precise load roller forces to be generated.

By applying a known force to wheel assembly 106 with load roller 108 and monitoring an output of sensor 121, controller 122 can determine the wheel assembly 106 spring rate variation. Upon first contact of load roller 108 and wheel assembly 106 under test, a diameter of wheel assembly 106 in a lightly loaded state is determined. One or more target forces to be applied by load roller 108 are determined from the unloaded diameter. An effective diameter at both of these roller forces is measured and together with the computed forces, the tire stiffness (spring rate) is determined. The diameter measurements of this measuring process are displayed and/or stored for further processing. The diameter measurements are accurate and repeatable within approximately 0.0020″. In addition, the effective diameter measurement includes effects due to tire stiffness and inflation pressure because of the loading. The effective diameter measurement is only slightly different than the actual effective diameter of wheel assembly 106 as mounted on the traveling vehicle because load roller 108 distorts the tire slightly differently than a flat road and also because a lower force is used for load roller 108 against wheel assembly 106 than as mounted on the vehicle. However, approximately 60% of the tire load rating is a target force for this system that has been shown to be accurate and repeatable enough to be used as a precision difference comparison gauge of diameters between two or more wheels. A diameter measurement “error” due to using a round roller at slightly lower force occurs to the same degree between wheels on the same balancer and therefore the error cancels when comparing the results of two wheels.

Benefits of performing a wheel assembly diameter measurement off of the vehicle and on a wheel assembly service system include timely identification of a diameter mismatch between wheel assemblies before mounting on the vehicle and beginning an alignment procedure. The measurement cannot be affected by temporary loading of the vehicle such as with a pickup truck or how much fuel is in the tank, because the wheel is off of the vehicle. The comparison between wheel assemblies is naturally consistent and accurate because each wheel is mounted to the same exact apparatus for the measurements. Because the diameter is directly being measured, multiple diameter readings can be obtained for multiple revolutions and averaged. This removes any diameter error caused by mis-centering of the wheel on the balancer. On an aligner, each wheel is mounted to a different corner of the vehicle where measurements can be affected by differences in geometries of the four corners of the vehicle on the rack and even by differences in accuracy/calibration of the separate vision systems looking at the four separate corners of the vehicle, including errors in the rolling compensation for determining centering of the mounted optical targets. The balancer can prompt and provide inflation for the wheel and store the achieved pressure so that effective diameter differences due to varying air pressures are automatically prevented.

In an embodiment, vehicle wheel service system 100 may be used to determine wheel assembly parameters for a plurality of wheel assemblies. The determined wheel assembly parameters may be other than the effective diameter of the wheel assembly or a parameter determined using a loading of the wheel assembly. The determined parameters may be stored such that over time a plurality of wheel assembly parameters are available for comparison to newly determined parameters from recently tested wheel assemblies or any other previously determined wheel parameters already stored in a memory. Controller 122 is configured to store determined wheel assembly parameter from a plurality of wheel assemblies and compare one of the stored wheel assembly parameters to at least one of another stored wheel assembly parameter and the determined wheel assembly parameter. Based on the comparison, controller 122 may determine wheel assemblies that may be used together forming a set that meet predetermined specifications.

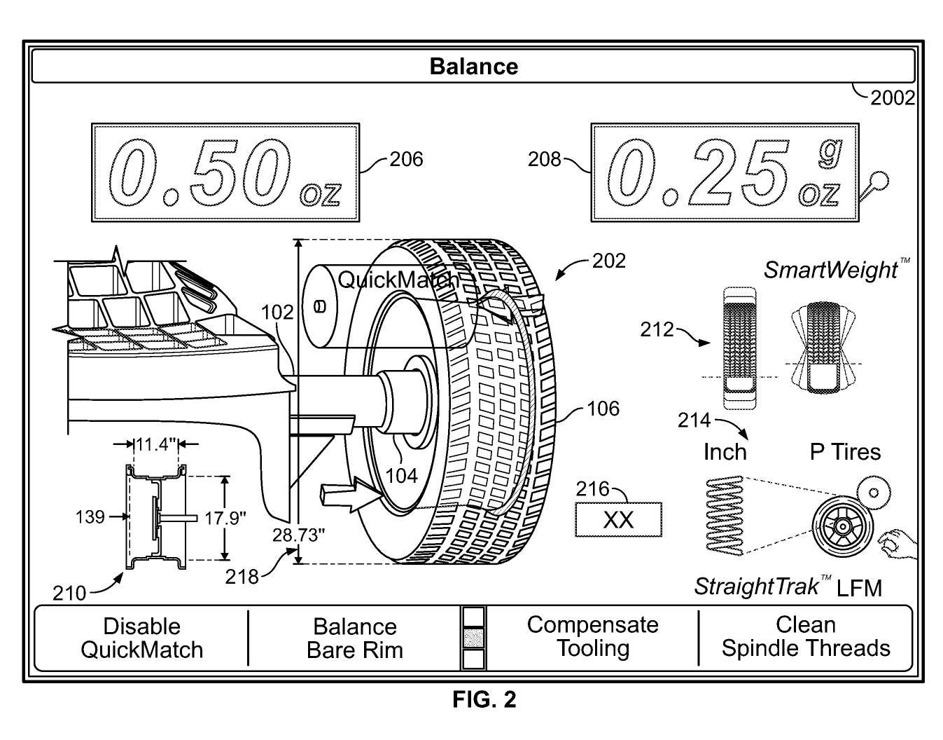

FIG. 2 is a screen display 200 of an exemplary user interface that may be used with wheel assembly service system 100 (shown in FIG. 1). Screen display 200 is a main display that includes a graphical representation 202 of a portion of wheel assembly service system 100 including spindle 102 and shaft encoder 104. Wheel assembly 106 is depicted as being mounted on spindle 102. Various data fields are illustrated in the exemplary display 200, namely display 200 includes a first balance weight amount field 206 and a second balance weight amount field 208, a rim measurement display field 210, and proprietary wheel service feature display fields 212 and 214. Each of the display fields are selectable for the particular feature displayed at any time. A key pad or a touch screen may be used to select a feature displayed in each field. An index field 216 may be displayed for each wheel assembly 106 mounted on spindle 102. The index field may contain, for example, but not limited to an alphanumeric identifier for the wheel assembly 106 currently mounted on spindle 102. The alphanumeric identifier may be entered by a user when switching between different wheel assemblies 106, may be automatically assigned for each new wheel assembly 106 installed on spindle, and/or alphanumeric identifier for each wheel assembly 106 may be inscribed on each wheel assembly 106 such that wheel assembly service system 100 is able to read or decode the inscribed identifier using for example, radio frequency identification (RFID), bar codes, or other machine readable methods, as well as manually writing an identifier on wheel assembly 106 and manually entering the alphanumeric identifier each time wheel assembly 106 is mounted to spindle 102. During a measurement of a diameter of wheel assembly 106, a display 218 of the measurement may be overlaid on graphical representation 202. Display 218 may include a newly acquired measurement of the wheel assembly 106 currently installed or may include a previously acquired measurement retrieved from a memory of wheel assembly service system 100. Display 218 may include an unloaded value of the diameter of wheel assembly 106 and/or a loaded value of the diameter of wheel assembly 106. In addition to or instead of the diameter value, display 218 may include other dimensional parameters of wheel assembly 106, such as, but not limited to a revolutions per distance traveled, distance traveled per revolutions, radius and a circumference wherein such parameters may be acquired in a loaded or unloaded state of the wheel assembly using contact or non-contact measurements.

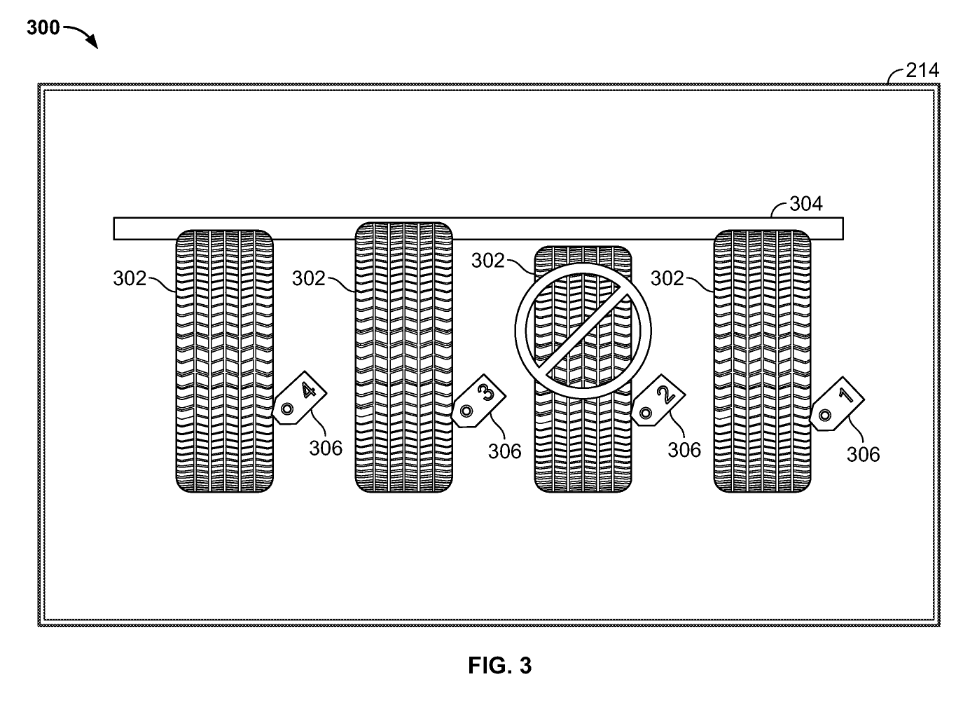

FIG. 3 is a screen display 300 of a portion of a user interface including an exemplary wheel service feature display field 214 that may be used with wheel assembly service system 100 (shown in FIG. 1). Field 214 includes a graphic representation of each wheel assembly 106 in a set of wheels, for example, for a single vehicle. Alternatively, field 214 includes a graphic representation 302 of each wheel assembly 106 in any group of wheels that are being matched in accordance with embodiments of the present invention. Each representation may be relatively sized in field 214 according to the measured parameter of the respective wheel assembly 106 being represented. Field 214 also includes a graphic representation of a tolerance limit 304 for the parameter being measured. Each wheel assembly 106 may be measured in succession and each parameter value may be shown graphically for each respective wheel assembly 106. If all of the wheel assemblies 106 are within tolerance limit 304, the graphic representation of a tolerance limit 304 may be displayed in a particular color, for example, green. However, if one or more of the wheel assemblies 106 are measured outside of tolerance limit 304, the graphic representation of a tolerance limit 304 may be colored another color, for example, yellow or red to alert the user that an out of tolerance condition exists. Additionally, the out-of-tolerance wheel assembly 106 may be highlighted using, for example, an international “NO” symbol overlaid on the graphical representation of the respective wheel assembly 106. Each of the graphical representations of the respective wheel assembly 106 may also include an index field 306 that permits identifying the respective wheel assemblies 106. Index field 306 may include the alphanumeric identifier of index field 216 (shown in FIG. 2).

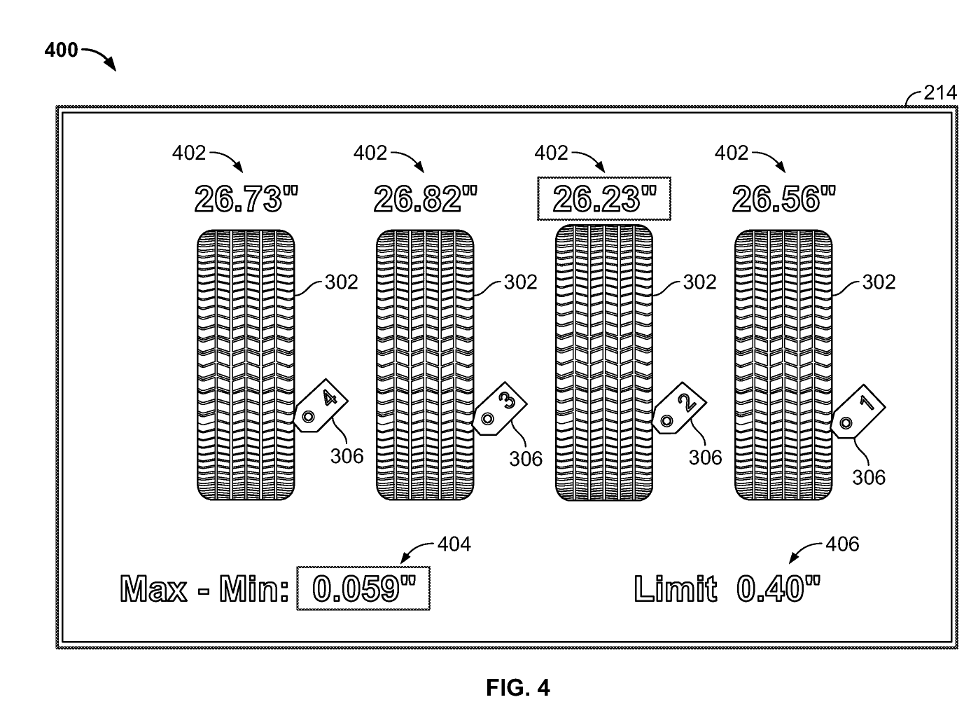

FIG. 4 is a screen display 400 of a portion of a user interface including another wheel service feature display field 214 that may be used with wheel assembly service system 100 (shown in FIG. 1). In this embodiment, field 214 includes a graphic representation of each wheel assembly 106 in a set of wheels, for example, for a single vehicle or for two opposing wheels on opposite sides of the vehicle if the wheel assemblies are associated with an independent suspension system. Alternatively, field 214 includes a graphic representation 302 of each wheel assembly 106 in any group of wheels that are being measured in accordance with embodiments of the present invention. Each representation may be accompanied by a respective text based parameter field 402 that displays a value for a measured parameter for each wheel assembly 106. Field 214 also includes a textual representation of a maximum-minimum range 404 and a tolerance limit 406 for the parameter being measured. Each wheel assembly 106 may be measured in succession and each parameter value may be shown textually for each respective wheel assembly 106. If the “max−min” difference 404 between the wheel assemblies 106 are within tolerance limit 406, field 402 may be displayed in a particular color, for example, green. However, if one or more of the wheel assemblies 106 cause the “max−min” difference to exceed the tolerance limit 406, the graphic representation of field 402 may be colored another color, for example, yellow or red to alert the user that an out of tolerance condition exists. Additionally, the out-of-tolerance wheel assembly 106 may be highlighted using, for example, an international “NO” symbol overlaid on the graphical representation of the respective wheel assembly 106 as shown in FIG. 3. Each of the graphical representations of the respective wheel assembly 106 may also include index field 306 that permits identifying the respective wheel assemblies 106. Index field 306 may include the alphanumeric identifier of index field 216 (shown in FIG. 2). The tolerance limit may refer to a difference tolerance limit where a limit of the measured parameter is referenced with respect to each other wheel assembly in the group or may refer to an absolute limit where the measured parameter of each wheel assembly in the group is compared to an absolute limit.

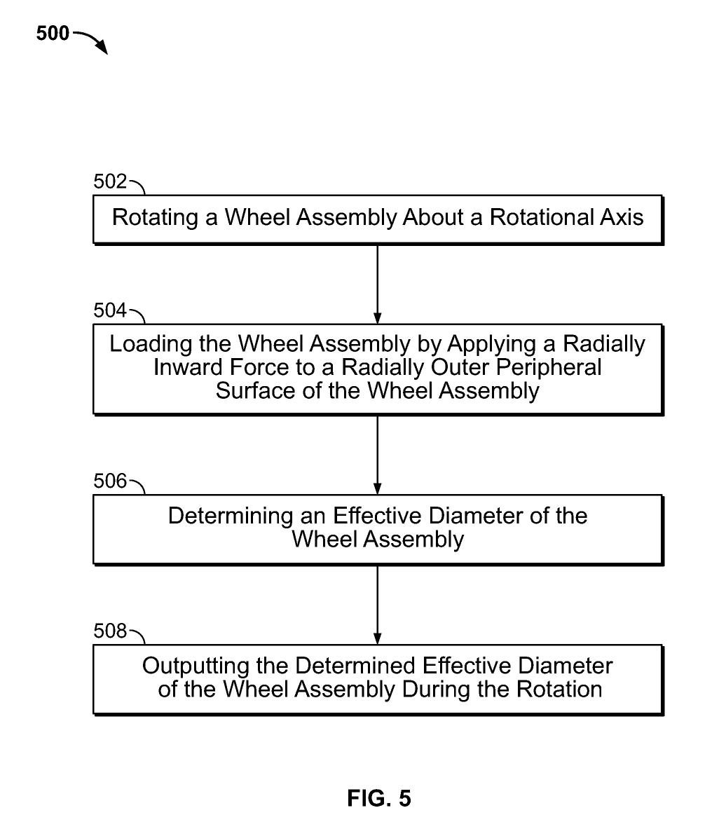

FIG. 5 is a flow diagram of an exemplary method 500 of determining a consistency of a measured parameter of wheel assembly 106. Method 500 includes rotating 502 a first wheel assembly 106 about a rotational axis and determining an effective diameter of the first wheel assembly 106 during the rotation. The effective diameter is determined by loading 504 wheel assembly 106 by applying a radially inward force to a radially outer peripheral surface of wheel assembly 106. Method 500 also includes outputting 508 the determined effective diameter of the wheel assembly 106 during the rotation.

Method 500 may be used to determine an effective diameter for a single wheel assembly 106 and the determined effective diameter compared to a tolerance range. If the effective diameter of wheel assembly 106 exceeds the range, an indication may be displayed and/or transmitted to alert a user of the condition. Method 500 may also be used to determine an effective diameter of a plurality of wheel assemblies 106, for example a set of wheel assemblies 106 from a single vehicle, or a set of wheel assemblies 106 assembled from various sources, for example, a fleet of vehicles, in an attempt to make a set that is within the tolerance range with respect to each other wheel or with respect to an absolute tolerance for each wheel assembly. When the effective diameters for all the wheel assemblies in the set are determined, the effective diameters are compared to determine if the set of wheel assemblies 106 are within a difference tolerance range and therefore may be used together as a set on a vehicle or in the case of an independent suspension, as two opposing wheel assemblies on opposite sides of the vehicle. As used herein, the difference tolerance range refers to a range of effective diameters that includes all wheel assemblies of the set. For example, if the difference tolerance range is 0.05″, none of the wheel assemblies would have an effective diameter that differed from the effective diameter of any other wheel assembly by more than 0.05″. A plurality of effective diameters of previously measured wheel assemblies 106 may be stored in memory 123 and retrieved at any time to compare to the determined effective diameters of currently measured wheel assemblies 106 to attempt to find a set that is within the tolerance range. If the effective diameter difference of the wheel assemblies 106 exceeds the difference tolerance range, an indication may be displayed and/or transmitted to alert a user of the condition. Additionally, if the effective diameter of any of the wheel assemblies 106 exceeds an absolute tolerance range, an indication may be displayed and/or transmitted to alert a user of the condition.

Although described in terms of “effective diameter” any equivalent measurement is contemplated for example, but not limited to a revolutions per distance traveled, distance traveled per revolutions, circumference, a diameter, and a radius of the wheel assembly. As used herein, “load roller” refers to a load device such as a static load pusher or any device that can apply a load to the tire regardless of whether the wheel assembly is rotated or not when using the load roller.

The term controller, as used herein, refers to processors, central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory 123 for execution by controller 122 or processor associated with controller 122, including RAM memory, ROM memory, EPROM memory, EEPROM memory, and non-volatile RAM (NVRAM) memory. The above memory types are exemplary only, and are thus not limiting as to the types of memory usable for storage of a computer program.

As will be appreciated based on the foregoing specification, the above-described embodiments of the disclosure may be implemented using computer programming or engineering techniques including computer software, firmware, hardware or any combination or subset thereof, wherein the technical effect is determining an effective diameter of a wheel assembly. The effective diameters of one or more wheel assemblies are compared to each other and to a tolerance range. The air pressure in the tire may also be adjusted to modify the effective diameter to bring it into tolerance in some tires. The effective diameter is displayed during the measurement to assist an operator determine when respective wheel assemblies are within tolerance. The controller is able to use effective diameters for wheel assemblies stored in memory to facilitate assembling a set of wheel assemblies that includes wheel assemblies 106 that are all within tolerance range. Any such resulting program, having computer-readable code means, may be embodied or provided within one or more computer-readable media, thereby making a computer program product, i.e., an article of manufacture, according to the discussed embodiments of the disclosure. The computer readable media may be, for example, but is not limited to, a fixed (hard) drive, a removable drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

The above-described embodiments of a method and system of determining an effective diameter of a wheel assembly provides a highly accurate, cost-effective and reliable means for determining a consistency of measurement between parameters of a wheel assembly. More specifically, the methods and systems described herein facilitate measuring the diameter of the tire/wheel assembly in unloaded and/or loaded conditions. As a result, the methods and systems described herein facilitate automatically measuring a parameter of the wheel assembly and displaying the parameter to a user during the measurement in a cost-effective and reliable manner.

Although described herein as the dimensional parameter being acquired in a loaded state using a load device or in an unloaded or lightly loaded state, the dimensional parameter may also be acquired using an optical profiling or scanning system or other non-contact measurement means.

While the disclosure has been described in terms of various specific embodiments, it will be recognized that the disclosure can be practiced with modification within the spirit and scope of the claims.

What is claimed is:

1. A wheel assembly service system comprising:
a rotatable spindle configured to receive a wheel assembly;
a load device configured to apply a load to the wheel assembly; and
a controller configured to:
control the load device to apply the load to the wheel assembly;
determine an effective diameter of the wheel assembly based on the applied load; and
output the determined effective diameter.

2. A wheel assembly service system in accordance with claim 1 wherein the controller is configured to compare the determined effective diameter to a stored tolerance range.

3. A wheel assembly service system in accordance with claim 2 wherein the effective diameter includes effects due to tire stiffness and inflation pressure.

4. A wheel assembly service system in accordance with claim 2 wherein the effective diameter comprises a measurement of the diameter of the wheel assembly under a known radial load wherein the tire is being compressed such that a spring rate of the tire contributes to the measurement.

5. A wheel assembly service system in accordance with claim 1 wherein said effective diameter is represented by at least one of a revolutions per distance traveled, distance traveled per revolution, a circumference, a diameter, and a radius of the wheel assembly.

6. A wheel assembly service system in accordance with claim 1 wherein said controller is configured to display the determined effective diameter in at least one of a graphical form and a numeric form.

7. A wheel assembly service system in accordance with claim 1 wherein said controller is configured to store the determined effective diameter in a memory associated with the controller.

8. A wheel assembly service system in accordance with claim 7 wherein said controller is further configured to:
compare a determined effective diameter to the stored effective diameter; and
output an alert indication if the comparison exceeds a determined range.

9. A wheel assembly service system comprising a controller configured to:
determine a wheel assembly dimensional parameter;
store said determined wheel assembly dimensional parameter from a plurality of wheel assemblies; and
compare one of the stored wheel assembly dimensional parameters to at least one of another stored wheel assembly dimensional parameter and the determined wheel assembly dimensional parameter.

10. A wheel assembly service system in accordance with claim 9 wherein said controller is configured to display the determined wheel assembly dimensional parameter in at least one of a graphical form and a numeric form.

11. A wheel assembly service system in accordance with claim 9 wherein said controller is configured to compare the determined wheel assembly dimensional parameter to a stored tolerance range.

12. A wheel assembly service system in accordance with claim 9 wherein said controller is configured to compare the determined wheel assembly dimensional parameter and at least one other stored wheel assembly dimensional parameter to a difference tolerance range.

13. A wheel assembly service system in accordance with claim 9 wherein said wheel assembly parameter comprises at least one of a revolutions per distance traveled, distance traveled per revolution, a circumference, a diameter, and a radius of the wheel assembly.

14. A method of determining a dimensional parameter of a wheel assembly, said method comprising:
rotating a first wheel assembly about a rotational axis;
determining a dimensional parameter of the first wheel assembly during the rotation; and
outputting the determined dimensional parameter of the first wheel assembly during the rotation.

15. A method in accordance with claim 14 further comprising storing the determined dimensional parameter in a memory.

16. A method in accordance with claim 14 further comprising:
determining a dimensional parameter of a second wheel assembly during a rotation of the second wheel assembly; and
comparing the determined dimensional parameter of the first wheel assembly to at least one of the determined dimensional parameter of the second wheel assembly and a determined dimensional parameter difference tolerance range.

17. A method in accordance with claim 14 wherein said controller is configured to compare the determined wheel assembly dimensional parameter to a stored tolerance range.

18. A method in accordance with claim 14 further comprising determining an effective diameter of the first wheel assembly during the rotation by applying a load to the wheel assembly using a load device.

19. A wheel assembly service system comprising:
a spindle configured to receive a wheel assembly, the wheel assembly comprising a rim and a tire mounted on the rim, said spindle configured to rotate the wheel assembly about a rotational axis of the wheel assembly;
a load device configured to apply a load to the wheel assembly;
a controller communicatively coupled to said spindle and said load device, said controller configured to control a rotation of the spindle and a force applied to the wheel assembly using the load device, said controller further configured to:
determine an effective diameter of each wheel assembly while in a loaded state;
store the determined effective diameters in a memory associated with the controller;
display the effective diameter of one or more of the wheel assemblies.

20. A wheel assembly service system in accordance with claim 19 wherein said controller is further configured to:
compare the determined effective diameter of one of the wheel assemblies to the determined effective diameters of another one of the wheel assemblies; and
output an indication if the comparison exceeds a determined range.

21. A wheel assembly service system in accordance with claim 19 wherein said controller is further configured to output an indication if the effective diameter exceeds a determined range.
